(19) United States
(12) Patent Application Publication
(10) Pub. No.: US 2016/0341881 A1
(43) Pub. Date: Nov. 24, 2016

(54) NARROW BORDER BACKLIGHT MODULE AND MOBILE TERMINAL

(71) Applicant: SHENZHEN CHINA STAR OPTOELECTRONICS TECHNOLOGY CO., LTD., Shenzhen, Guangdong (CN)

(72) Inventors: Qing GUO, Shenzhen, Guangdong (CN); Chen XIE, Shenzhen, Guangdong (CN)

(73) Assignee: Shenzhen China Star Optoelectronics Technology Co., Ltd., Shenzhen, Guangdong (CN)

(21) Appl. No.: 14/433,669

(22) PCT Filed: Jan. 5, 2015
(86) PCT No.: PCT/CN2015/070104

§ 371 Date: Apr. 5, 2015

(30) Foreign Application Priority Data
Dec. 24, 2014 (CN) 201410817444.4

(51) Int. Cl. F21V 8/00; G02F 1/1335

(52) U.S. Cl. CPC G02B 6/0053; G02B 6/0088; G02F 1/133528

(57) ABSTRACT

The present invention provides a mobile terminal and a narrow border backlight module thereof. The narrow border backlight module includes a light guide plate; an optical film, disposed on the light guide plate; a plastic frame, disposed around an outer edge of the light guide plate, and an upper spreading film, stick onto the plastic film and covering the light guide plate and the optical film for preventing falling off of the optical film, a shading tape being further disposed on the upper spreading film for preventing light leakage between the light guide plate and the plastic frame. The present invention eliminates the light source defects, completely prevent falling off of optical films and prevent light leakage, and thus the plastic frame of the backlight module can be designed to be narrower.

### TECHNICAL FIELD

The present invention relates to liquid crystal displays, and more particularly, relates to a narrow border backlight module, and a mobile terminal including the narrow border backlight module.

### BACKGROUND

With the development of mobile communication products and pad computers, many mobile phone producers take “narrow border” as a selling point to attract consumers. The width of the plastic frame in a backlight module directly affects the width of the border of mobile phones.

In conventional backlight modules, a black-white or black-black hollow square adhesive tape is usually stick on the plastic frame to bond the liquid crystal module and the backlight module for preventing films falling off. At the same time, the hollow square adhesive tape is also used to fill the gap between the light guide plate in the backlight module and the plastic frame to prevent light leakage.

Therefore, an inner edge of the hollow square adhesive tape is required to reach the optical film for preventing falling off of the films, and the overlapping width of the tape is also required to more than a certain value. At the same time, the hollow square adhesive tape is stick onto the plastic frame, adequate stability is required, and thus a certain width of the plastic frame is also required. Accordingly, the minimum width of the plastic frame is required.

The border width of a backlight module is usually the length between an outer side surface of the plastic frame and an inner edge of the hollow square adhesive tape. Since both the width of the plastic frame and the hollow square adhesive tape have the minimum value, and the cutting ability of the hollow square adhesive tape is also limited, it is very difficult to achieve an extremely narrow border. To further decrease the width of the border, the limitations of plastic frame and hollow square adhesive tape need to be overcome.

Referring to FIG. 1, FIG. 1 is a simplified schematic view of an inner structure of a mobile terminal in the known art.

As shown in FIG. 1, the mobile terminal includes a backlight module at below and a liquid crystal display (LCD) module at top. The backlight module provides light source to the top LCD module.

The LCD module includes a lower polarizer 142, a liquid crystal layer, and an upper polarizer 144, stacked sequentially together.

The backlight module includes a light guide plate 110, a plastic frame 120, a reflective plate 112, a lower spreading film 114, a lower prism 116 and an upper prism 118.

The plastic frame 120 is disposed around an outer edge of the light guide plate 11, the reflective plate 112 is disposed at a bottom surface of the plastic frame 12, and the light guide plate 110 is disposed on the reflective plate 112. The lower spreading film 114, the lower prism 116 and the upper prism 118 are sequentially disposed on the light guide plate 110.

The hollow square adhesive tape 130 is rectangular, and is stick onto the plastic frame 120, en inner edge of the hollow square adhesive tape 130 extends to cover an outer edge of the upper prism 118 thereby preventing falling off of films. At the same time, the hollow square adhesive tape 130 is also used to cover a gap between the upper prism 118 and the plastic frame 120 thereby preventing the light leakage. As a certain sticking stability between the hollow square adhesive tape 130 and the plastic frame 120 is required, the width of the plastic frame 120 should have adequate width for meeting the stability requirements.

### SUMMARY

The present invention provides a narrow border backlight module, which solves the problem that the hollow square adhesive tape can't be made narrower.

To solve the above problem, an embodiment of the present invention provides a narrow border backlight module.

The backlight module includes a light guide plate, an optical film disposed on the light guide plate, a plastic frame disposed around an outer edge of the light guide plate, an upper spreading film stick on the plastic frame and covers the light guide plate and the optical film for preventing falling off of the optical film. At least one shading tape is disposed on the spreading film to shade the leaked light from the gap between the light guide plate and the plastic frame.

The upper spreading film is rectangular, and includes two long sides and two short sides. The number of the shading tape is two, and the two shading tapes are disposed on the long sides of the spreading film, respectively.

The optical film includes a lower spreading film, a lower prism sheet and an upper prism sheet sequentially stacked together. The lower spreading film, the lower prism sheet and the upper prism sheet have a same area to the light guide plate, the shading tape covers the gap between the light guide plate and the plastic film, and extends to an outer edge of the upper prism for preventing the light leakage.

To solve the above problem, an embodiment of the present invention further provides a narrow border backlight module, which includes a light guide plate, an optical film disposed on the light guide plate, a plastic frame disposed around an outer edge of the light guide plate, and an upper spreading film stick onto the plastic frame and covering the light guide plate and the optical film for preventing falling off of the optical film. At least one shading tape is disposed on the spreading film to shade the leaked light from the gap between the light guide plate and the plastic frame.

In one embodiment, the upper spreading film is rectangular, and includes two long sides and two short sides. The number of the shading tape is two, and the two shading tapes are disposed on the long sides of the spreading film, respectively.

In one embodiment, the shading tape is integrally formed in the upper spreading film into a unitary piece, or the shading tapes are formed on a top surface, or a bottom surface, or both the top and bottom surfaces of the upper spreading film using an ink injection printing process or a sticking process.

In one embodiment, if the shading tape is formed on the top or bottom surface of the upper spreading film using the ink injection printing process, the shading tape is a black shading ink layer on the top or the bottom surface.

In one embodiment, if the shading tape is formed on both the top or bottom surfaces of the upper spreading film using the ink injection printing process, the shading tape is a black shading ink layer on the top surface, and is a white reflective ink layer or a black shading ink layer on the bottom surface.

In one embodiment, if the shading tape is stick onto the top or bottom surface of the upper spreading film, the shading tape is a black shading tape on the top or the bottom surface.

In one embodiment, if the shading tape is stick onto both the top or bottom surfaces of the upper spreading film, the shading tape is a black shading tape on the top surface, and is a white reflective tape or a black shading tape on the bottom surface.

In one embodiment, the optical film includes a lower spreading film, a lower prism sheet and an upper prism sheet sequentially stacked together, the lower spreading film, the lower prism sheet and the upper prism sheet having the same area to that of the light guide plate, the shading tapes covering a gap between the light guide plate and the plastic frame and extending to cover an outer edge of the upper prism sheet for preventing light leakage.

In one embodiment, the narrow border backlight module further includes a reflective plate disposed at a bottom surface of the plastic film. The light guide plate is disposed on the reflective plate.

To solve the above problem, an embodiment of the present invention provides a mobile terminal, which includes a liquid crystal module and the above narrow border backlight module. The narrow border backlight module provides light source to the liquid crystal module.

The above embodiments have the following advantages. Differing from the known art, the narrow border backlight module provided the present invention further includes an upper spreading film which is capable of eliminating the light source defects and completely preventing the falling off of the optical film. In addition, two shading tapes are disposed on the upper spreading film for preventing light leakage and restrictions of the sticking force of the hollow square adhesive tape also doesn't exist. Therefore, the plastic frame of the backlight module can be made narrower.

### BRIEF DESCRIPTION OF THE DRAWINGS

To illustrate the technical solution provided by embodiments of the present invention more clearly, the figures used to illustrate the embodiments are introduced as follows. Obviously, the listed figures only illustrate some embodiments of the present invention. Those one of ordinarily skilled in the art can also obtain other figures according to the illustrated ones without any creative working.

FIG. 1 is a simplified schematic view of a known mobile terminal;

FIG. 2 is a simplified schematic view of an inner structure of a mobile terminal in accordance with an embodiment of the present embodiment;

FIG. 3 is a partially enlarged schematic view of an upper spreading film in the mobile terminal of FIG. 2; and

FIG. 4 is a cross sectional schematic view of an embodiment of the upper spreading film in FIG. 3;

FIG. 5 is a cross sectional schematic view of another embodiment of the upper spreading film in FIG. 3;

FIG. 6 is a cross sectional schematic view of still another embodiment of the upper spreading film in FIG. 3; and

FIG. 7 is a cross sectional schematic view of yet another embodiment of the upper spreading film in FIG. 3.

### DETAILED DESCRIPTION OF PREFERRED EMBODIMENTS

The technical details of embodiments of the present invention are described clearly and completely with the reference to the figures. Obviously, the described embodiments are only a part of the embodiments, and are not all the embodiments. Based upon these described embodiments, one of ordinarily skilled in the art can obtain other embodiments without any creative working, and these obtained embodiments should also be included in the scope of the present invention.

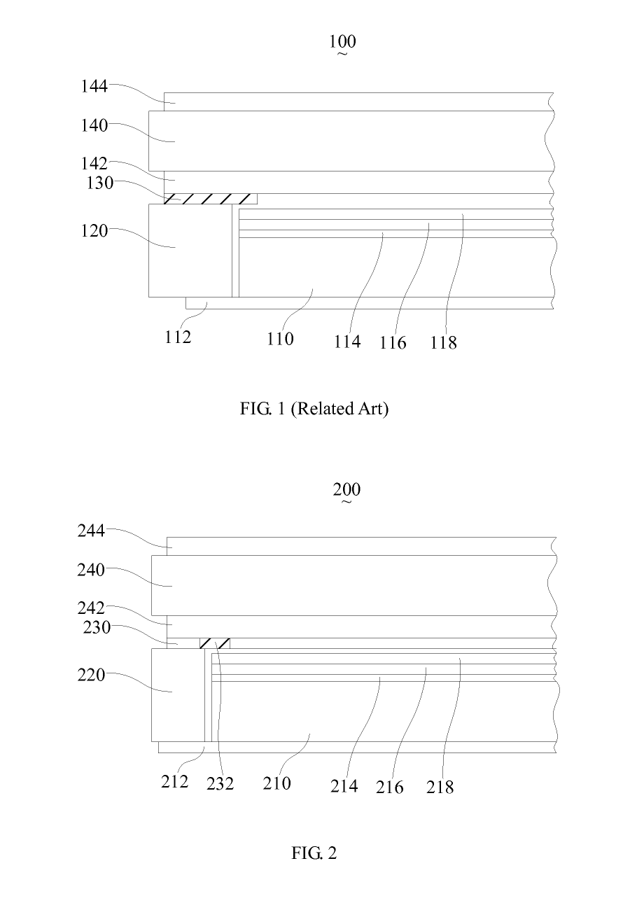

Referring to FIG. 2, FIG. 2 is a simplified schematic view of an inner structure of a mobile terminal in accordance with an embodiment of the present embodiment.

As shown in FIG. 2, the present invention provides a mobile terminal; the mobile terminal includes a narrow border backlight module at a bottom and a liquid crystal module at a top. The narrow border backlight module at the bottom provides light source to the liquid crystal module at the top.

The liquid crystal module includes a lower polarizer 242, a liquid crystal layer 240 and an upper polarizer 244 sequentially stacked together.

The narrow border backlight module includes a light guide plate 210, a light source (not shown), an optical film, a plastic frame 220 and an upper spreading film 230.

The light source is disposed at a side of the light guide plate 210, the optical film is disposed on the light guide plate 210, the plastic frame is disposed around an outer edge of the light guide plate 210, the upper spreading film 230 is disposed on the plastic frame 220 and covers the light guide plate 210 and the optical film for preventing falling off of the optical film. A shading tape 232 is further disposed on the upper spreading film 230 for shading the light leaked between the light guide plate 210 and the plastic frame 220.

The upper spreading film 230 is rectangular, and includes two long sides and two short sides. The number of the shading tape 232 may be two, and the two shading tapes 232 are disposed on the two long sides of the upper spreading film, respectively. Of course, the number of the shading tape 232 may be also four, and the four shading tapes 232 may be disposed on the four sides of the upper spreading film 230, respectively.

The optical film includes a lower spreading film 214 disposed on the light guide plate 210, a lower prism sheet 216, and an upper prism sheet 218. The lower spreading film 214, the lower prism sheet 216 and the upper prism sheet 218 have the same area to that of the light guide plate 210. The shading tape 232 covers a gap between the light guide plate 210 and the plastic frame 220 and extends to overlap with an outer edge of the upper prism sheet 218 for preventing light leakage.

The narrow border backlight module may further include a reflective plate 212, the reflective plate 212 is disposed on a bottom surface of the plastic frame 220, the light guide plate 210 is disposed on the reflective plate 212.

It is worthy to mention that the hollow square adhesive tape 130 should be made into a rectangular shape in the known art. However, by employing the upper spreading film 230, only two black shading tapes 232 should be formed on the two long sides of the upper spreading film 230. Mobile terminals such as mobile phones require a narrow border at the left and right sides, but the border width at the top and the bottom is not strictly restricted. Thus, to improve the sticking force, the contacting area of the upper spreading film 230 at the top and the bottom, where there are not the shading tapes 232, can be increased.

As such, the upper spreading film 230 significantly decreases the width of the plastic frame 220 at the long sides of mobile terminals, and thus, light leakage is prevented, and falling off of the optical film (the lower spreading film 214, the lower prism sheet 216 and the upper prism sheet 218) is also completely prevented, and the defects of light source are also eliminated.

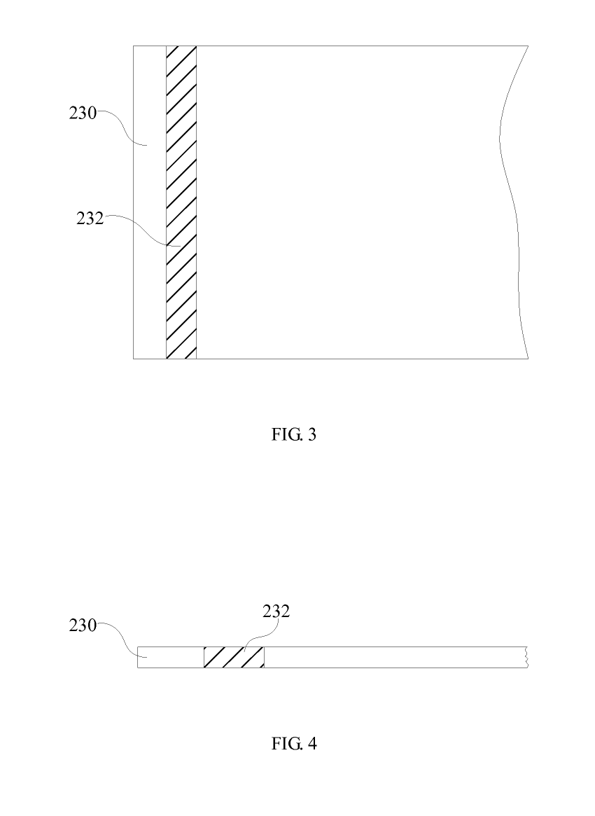

Referring to FIGS. 3 and 4 together, FIG. 3 is a partially enlarged schematic view of an upper spreading film in the mobile terminal of FIG. 2; and FIG. 4 is a cross sectional schematic view of an embodiment of the upper spreading film in FIG. 3.

In the present embodiment, the shading tape 232 is integrally formed in the upper spreading film 230 into a unitary piece.

Specifically, the shading tape 232 can be integrally formed on the two long sides of the upper spreading film 230. An inner edge of the shading tape 232 extends to overlap with an outer edge of the upper prism sheet 218, and an overlapping width is same to that of the known art, but an outer edge of the shading tape 232 is not required to be stick onto the plastic frame 220. Thus, the width of the shading tape 232 is far smaller than the width of the hollow square adhesive tape 130.

The upper spreading film 230 is not disposed on the upper prism sheet 218, and is stick onto the plastic frame 220. Because the restrictions of the hollow square adhesive tape 130 don't exist now, what is required is only to stick the upper spreading film 230 onto the plastic frame 220. The width of the long sides of the plastic frame 220 can be decreased in an appropriate ratio, when the mechanical strength is adequate. To assure the entire bonding force, the contacting area can be increased at the two short sides of the upper spreading film 230.

Referring to FIGS. 3 and 5, FIG. 5 is a cross sectional schematic view of another embodiment of the upper spreading film in FIG. 3.

In the present embodiment, the shading tape 232 is formed on a bottom surface of the upper spreading film 230.

The shading tape 232 can be formed on the bottom surface of the upper spreading film 230 using an ink injection printing process, or the shading tape 232 can be stick onto the bottom surface of the upper spreading film 230.

If the shading tape 232 is formed on the bottom surface of the upper spreading film 230 using the ink injection printing process, the shading tape 232 is a black shading ink layer on the bottom surface.

If the shading tape 232 is stick onto the bottom surface of the upper spreading film 230, the shading tape 232 is a black shading tape on the bottom surface.

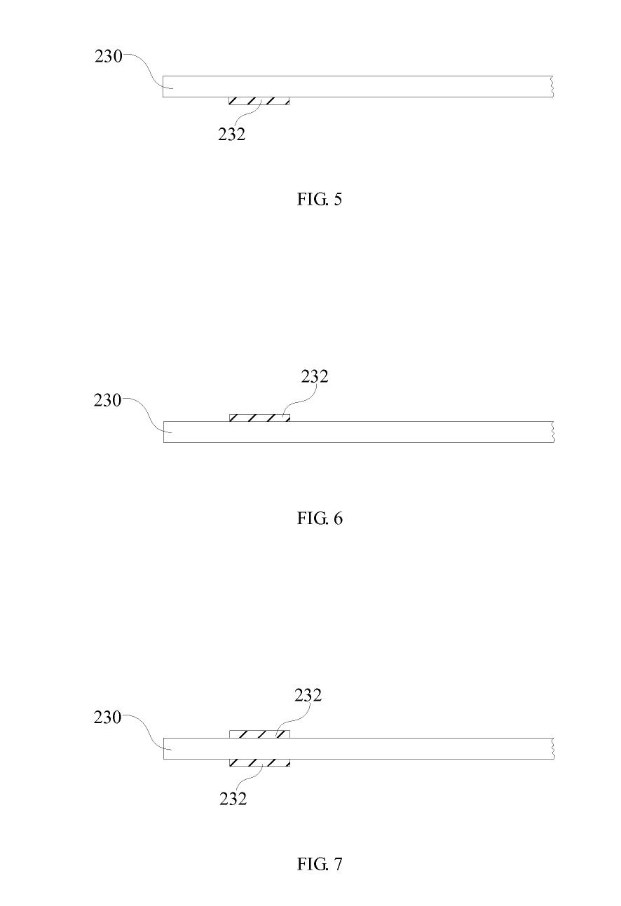

Referring to FIGS. 3 and 6, FIG. 6 is a cross sectional schematic view of still another embodiment of the upper spreading film in FIG. 3.

In the present embodiment, the shading tape 232 is formed on a top surface of the upper spreading film 230.

The shading tape 232 can be formed on the top surface of the upper spreading film 230 using an ink injection printing process, or the shading tape 232 can be stick onto the top surface of the upper spreading film 230.

If the shading tape 232 is formed on the top surface of the upper spreading film 230 using the ink injection printing process, the shading tape 232 is a black shading ink layer on the top surface.

If the shading tape 232 is stick onto the top surface of the upper spreading film 230, the shading tape 232 is a black shading tape on the top surface.

Referring to FIGS. 3 and 7, FIG. 7 is a cross sectional schematic view of yet another embodiment of the upper spreading film in FIG. 3.

In the present embodiment, the shading tape 232 is formed on both the top and bottom surfaces of the upper spreading film 230.

The shading tape 232 can be formed on the top and bottom surfaces of the upper spreading film 230 using an ink injection printing process, or the shading tape 232 can be stick onto the top and bottom surfaces of the upper spreading film 230.

If the shading tape 232 is formed on the top and bottom surfaces of the upper spreading film 230 using the ink injection printing process, the shading tape 232 includes a black shading ink layer on the top surface, and includes a white reflective ink layer or a black shading ink layer on the bottom surface.

If the shading tape 232 is stick onto the top and bottom surfaces of the upper spreading film 230, the shading tape 232 includes a black shading tape on the top surface, and includes a white reflective tape or a black shading tape on the bottom surface.

In summary, it is easily to be understood by one of ordinarily skilled in the art the present invention adds the upper spreading film in the narrow border backlight module. The upper spreading film is capable of eliminating the light source defects and completely preventing the falling off of the optical film. In addition, two shading tapes are disposed on the upper spreading film for preventing light leakage and restrictions of the sticking force of the hollow square adhesive tape also doesn't exist. Therefore, the plastic frame of the backlight module can be made narrower.

The above description is only embodiment of the present invention, and is not used to limit the scope of the present invention. Any equivalent structure or equivalent flow alternatives made from the specification and figures of the present invention, such as combination of different embodiments, or direct or indirect application of the present invention into other related fields, should be included in the scope of the present invention.

What is claimed is:

1. A narrow border backlight module, comprising:
a light guide plate;
an optical film, disposed on the light guide plate;
a plastic frame, disposed around an outer edge of the light guide plate;
an upper spreading film, stick onto the plastic film and covering the light guide plate and the optical film for preventing falling off of the optical film, a shading tape being further disposed on the upper spreading film for preventing light leakage between the light guide plate and the plastic frame;
the upper spreading film being rectangular and comprising two long sides and two short sides, the number of the shading tapes being two, and the two shading tapes being disposed on the two long sides of the upper spreading film;
the optical film comprising a lower spreading film, a lower prism sheet and an upper prism sheet sequentially stacked together, the lower spreading film, the lower prism sheet and the upper prism sheet having the same area to that of the light guide plate, the shading tapes covering a gap between the light guide plate and the plastic frame and extending to cover an outer edge of the upper prism sheet for preventing light leakage.

2. A narrow border backlight module, comprising:
a light guide plate;
an optical film, disposed on the light guide plate;
a plastic frame, disposed around an outer edge of the light guide plate;
an upper spreading film, stick onto the plastic film and covering the light guide plate and the optical film for preventing falling off of the optical film, a shading tape being further disposed on the upper spreading film for preventing light leakage between the light guide plate and the plastic frame.

3. The narrow border backlight module of claim 2, wherein the upper spreading film is rectangular and comprises two long sides and two short sides, the number of the shading tapes being two, and the two shading tapes being disposed on the two long sides of the upper spreading film.

4. The narrow border backlight module of claim 3, wherein the shading tape is integrally formed in the upper spreading film into a unitary piece, or the shading tapes are formed on a top surface, or a bottom surface, or both the top and bottom surfaces of the upper spreading film using an ink injection printing process or a sticking process.

5. The narrow border backlight module of claim 4, if the shading tape is formed on the top or bottom surface of the upper spreading film using the ink injection printing process, the shading tape being a black shading ink layer on the top or the bottom surface.

6. The narrow border backlight module of claim 4, if the shading tape is formed on both the top or bottom surfaces of the upper spreading film using the ink injection printing process, the shading tape being a black shading ink layer on the top surface, and being a white reflective ink layer or a black shading ink layer on the bottom surface.

7. The narrow border backlight module of claim 4, if the shading tape is stick onto the top or bottom surface of the upper spreading film, the shading tape being a black shading tape on the top or the bottom surface.

8. The narrow border backlight module of claim 4, if the shading tape is stick onto both the top or bottom surfaces of the upper spreading film, the shading tape being a black shading tape on the top surface, and being a white reflective tape or a black shading tape on the bottom surface.

9. The narrow border backlight module of claim 2, wherein the optical film comprises a lower spreading film, a lower prism sheet and an upper prism sheet sequentially stacked together, the lower spreading film, the lower prism sheet and the upper prism sheet having the same area to that of the light guide plate, the shading tapes covering a gap between the light guide plate and the plastic frame and extending to cover an outer edge of the upper prism sheet for preventing light leakage.

10. The narrow border backlight module of claim 2, further comprising a reflective plate disposed at a bottom surface of the plastic frame, and the light guide plate is disposed on the reflective plate.

11. A mobile terminal, comprising a liquid crystal module and a narrow border backlight module, the narrow border backlight module providing light source to the liquid crystal module;
the narrow border backlight module, comprising:
a light guide plate;
an optical film, disposed on the light guide plate;
a plastic frame, disposed around an outer edge of the light guide plate;
an upper spreading film, stick onto the plastic film and covering the light guide plate and the optical film for preventing falling off of the optical film, a shading tape being further disposed on the upper spreading film for preventing light leakage between the light guide plate and the plastic frame.

12. The n mobile terminal of claim 11, wherein the upper spreading film is rectangular and comprises two long sides and two short sides, the number of the shading tapes being two, and the two shading tapes being disposed on the two long sides of the upper spreading film.

13. The mobile terminal of claim 12, wherein the shading tape is integrally formed in the upper spreading film into a unitary piece, or the shading tapes are formed on a top surface, or a bottom surface, or both the top and bottom surfaces of the upper spreading film using an ink injection printing process or a sticking process.

14. The mobile terminal of claim 13, if the shading tape is formed on the top or bottom surface of the upper spreading film using the ink injection printing process, the shading tape being a black shading ink layer on the top or the bottom surface.

15. The mobile terminal of claim 13, if the shading tape is formed on both the top or bottom surfaces of the upper spreading film using the ink injection printing process, the shading tape being a black shading ink layer on the top surface, and being a white reflective ink layer or a black shading ink layer on the bottom surface.

16. The mobile terminal of claim 13, if the shading tape is stick onto the top or bottom surface of the upper spreading film, the shading tape being a black shading tape on the top or the bottom surface.

17. The mobile terminal of claim 13, if the shading tape is stick onto both the top or bottom surfaces of the upper spreading film, the shading tape being a black shading tape on the top surface, and being a white reflective tape or a black shading tape on the bottom surface.

18. The mobile terminal of claim 11, wherein the optical film comprises a lower spreading film, a lower prism sheet and an upper prism sheet sequentially stacked together, the lower spreading film, the lower prism sheet and the upper prism sheet having the same area to that of the light guide plate, the shading tapes covering a gap between the light guide plate and the plastic frame and extending to cover an outer edge of the upper prism sheet for preventing light leakage.

19. The mobile terminal of claim 11, further comprising a reflective plate disposed at a bottom surface of the plastic frame, and the light guide plate is disposed on the reflective plate.
